(19) United States
(12) Patent Application Publication
(10) Pub. No.: US 2015/0259626 A1
(43) Pub. Date: Sep. 17, 2015

(54) DETERGENT COMPOSITION

(71) Applicant: The Procter & Gamble Company, Cincinnati, OH (US)

(72) Inventors: Andrei Sergeevich BUREIKO, Cincinnati, OH (US); Robin LEFEBVRE, Mechelen (BE); Christa Sue PELFREY, Colerain Township, OH (US); Cedric Joseph VOLONT, Laken (BE)

(21) Appl. No.: 14/645,441

(22) Filed: Mar. 12, 2015

Related U.S. Application Data
(60) Provisional application No. 61/951,606, filed on Mar. 12, 2014.

(51) Int. Cl. C11D 3/50; C11D 3/48; C11D 3/30; C11D 1/66; C11D 3/04; C11D 3/43

(52) U.S. Cl. CPC C11D 3/50; C11D 3/046; C11D 3/43; C11D 3/30; C11D 1/66; C11D 3/48

(57) ABSTRACT

A composition comprising an an aminoalcohol solvent, an alkali metal salt and a perfume formulation.

### FIELD OF THE INVENTION

The present invention relates to a detergent composition comprising an aminoalcohol solvent, an alkali metal salt selected from carbonate salt, silicate salt, phosphate salt, and sulphate salt, and a perfume formulation.

Those compositions may be particularly useful as stable hard surface cleaning compositions which can provide good cleaning, good shine to the surface to be cleaned without damaging it.

### BACKGROUND OF THE INVENTION

The formulator of cleaning compositions aims at providing the overall best experience to the consumer by creating compositions providing multiple benefits, such as good cleaning and good shine, altogether. The formulator also tries to provide compositions which are stable over time. This is particularly challenging as a change in the formula leading to a positive according to one aspect may induce a negative according to another aspect. For example, improving the cleaning properties of a composition may reduce the stability of the composition or reduce the shine of the cleaned surface.

### SUMMARY OF THE INVENTION

The invention concerns a detergent composition comprising:
(a) an aminoalcohol solvent,
(b) an alkali metal salt selected from carbonate salt, silicate salt, phosphate salt, and sulphate salt, and
(c) a perfume formulation,
   wherein the weight ratio of aminoalcohol solvent to alkali metal salt selected from carbonate salt, silicate salt, phosphate salt, and sulphate salt is comprised between about 1 and about 25, preferably between about 3 and about 10,
   and wherein the perfume formulation comprises at most about 50%, preferably at most about 30%, per weight of perfume raw materials comprising an ester function, an α, β-unsaturated aldehyde function and/or an α, β-unsaturated ketone function.

Composition according the invention provide a good overall experience to the consumer. The compositions of the invention may provide good cleaning and good shine to a surface without significantly damaging it. The composition of the invention may have acceptable stability overtime.

The invention also concerns a spraying device comprising a composition according to the invention. The invention also concerns the use of a composition according to the invention to provide cleaning and shine to a hard surface.

### DETAILED DESCRIPTION OF THE INVENTION

The composition comprises an aminoalcohol solvent, an alkali metal salt, and a perfume formulation.

### The Aminoalcohol Solvent

The composition comprises an aminoalcohol solvent.

The aminoalcohols may comprise monoethanolamine, monoisopropanolamine and mixtures thereof, most preferably said aminoalcohol comprises monoethanol amine (MEA).

The composition may comprise from about 0.02% to about 30% per weight of aminoalcohol solvent, for example from about 0.05% to about 20%, or from about 0.1% to about 10%, or from about 0.2 to about 5%, or from about 0.3 to about 2%, or from about 0.4 to about 1%.

The composition may comprise from about 0.02% to about 30% per weight of monoethanol amine (MEA), for example from about 0.05% to about 20%, or from about 0.1% to about 10%, or from about 0.2 to about 5% k, or from about 0.3 to about 2%, or from about 0.4 to about 1%.

### Alkali Metal Salt

The composition comprises an alkali metal salt selected from carbonate salt, silicate salt, phosphate salt and sulphate salt. Preferably, the alkali metal salt comprises carbonate salt or silicate salt. Preferably the alkali metal salt comprises carbonate salt.

The carbonate salt may be any carbonate salt, such as sodium carbonate and sodium bicarbonate. Preferably the carbonate salt is sodium carbonate.

The silicate salt may comprise sodium silicate. The sulphate salt may comprise sodium sulphate. The phosphate salt may comprise sodium tripolyphosphate.

The composition may comprise from about 0.01% to about 15% per weight of alkali metal salt selected from carbonate salt, silicate salt, phosphate salt, and sulphate salt, for example from about 0.02% to about 10% or from about 0.05% to about 5%. The composition may comprise less than about 2% or less than about 1% or less than about 0.5% or less than about 0.2% of alkali metal salt selected from carbonate salt, silicate salt, phosphate salt, and sulphate salt.

The composition may comprise from about 0.01% to about 15% per weight of carbonate salt, for example from about 0.02% to about 10% or from about 0.05% to about 5%. The composition may comprise less than about 2% or less than about 1% or less than about 0.5% or less than about 0.2% of carbonate salt.

The composition may comprise from about 0.01% to about 15% per weight of sodium carbonate, for example from about 0.02% to about 10% or from about 0.05% to about 5%. The composition may comprise less than about 2% or less than about 1% or less than about 0.5% or less than about 0.2% of sodium carbonate.

### Perfume Formulation

The composition comprises a perfume formulation. The perfume formulation is a mixture of odorant perfume raw materials, such as aromatic natural oils and aromatic chemicals, which taken together form a complex scent that delivers a number of benefits. These benefits may include the coverage of product base odor, scenting the product itself, and lingering scent radiating from the surface into the air after cleaning. When the composition is sprayed, the benefit may also include the delivery of scent to the air when spraying the composition on a surface, and the delivery of scent to the air while wiping the composition on the surface. The perfume formulation may comprise at least 3, at least 5, at least 7, at least 11, or at least 15 perfume raw materials.

The perfume raw materials of the perfume formulation comprises at most about 50%, or at most about 40%, or at most about 30%, for example from about 0% to about 20%, or from about 0.01% to about 10%, or from about 0.02% to about 5%, per weight of perfume raw materials comprising an α, β-unsaturated aldehyde function, an α, β-unsaturated ketone function, and/or an ester function.

For the purpose of the invention, an aromatic aldehyde/ketone wherein the aromatic ring is adjacent to the aldehyde or ketone group (e.g. anisic aldehyde or methyl β-naphthyl ketone) is considered as an α, β-unsaturated aldehyde/ketone.

The inventors have discovered that the use of the perfume of the invention in combination with a specific ratio of alkali metal salt and aminoalcohol solvent were particularly stable.

The perfume raw materials of the perfume formulation may comprise at most about 50%, or at most about 40%, or at most about 30% for example from about 0% to about 20%, or from about 0.01% to about 10%, or from about 0.02% to about 5% per weight of perfume raw materials selected from benzyl acetate, methyl salicylate, allyl amyl glycolate, benzyl propionate, pomarose, methyl dihydrojasmonate, heliotropin, anisic aldehyde, delta damascone, amyl butyrate, iso-amyl iso-butyrate, b-ionone, carvone, iso-butyl iso butanoate, methyl b-naphtyl ketone, citronellyl butyrate, iso-propyl miristate.

The perfume raw materials of the perfume formulation may comprise at least about 20% per weight, in particular at least about 30%, or at least about 40%, or at least about 50%, or at least about 60%, or at least about 70% for example from about 80% to about 100%, or from about 90% to about 99.9% per weight of perfume raw materials comprising an α, β-saturated aldehyde function, an α, β-saturated ketone function, an alcohol function, an ether function, a nitrile function, and/or being a terpene.

For the purpose of the invention an α, β-saturated aldehyde function is an aldehyde function without unsaturation in the α or β position.

For the purpose of the invention an α, β-saturated ketone function is a ketone function without unsaturation in the α or β position.

The perfume raw materials of the perfume formulation may comprise at least about 20% per weight, in particular at least about 30%, or at least about 40%, or at least about 50%, or at least about 60%, or at least about 70% for example from about 80% to about 100%, or from about 90% to about 99.9% per weight of perfume raw materials which do not comprise α, β-unsaturated aldehyde function, an α, β-unsaturated ketone function, and/or an ester function.

The perfume raw materials of the perfume formulation may comprise at least about 20% per weight, in particular at least about 30%, or at least about 40%, or at least about 50%, or at least about 60%, or at least about 70% for example from about 80% to about 100%, or from about 90% to about 99.9% per weight of perfume raw materials which comprise α, β-saturated aldehyde function, an α, β-saturated ketone function, an alcohol function, an ether function, a nitrile function, and/or are a terpene and which do not comprise an α, β-unsaturated aldehyde function, an α, β-unsaturated ketone function, and/or an ester function.

The perfume raw materials of the perfume formulation may comprise at least about 20% per weight, in particular at least about 30%, or at least about 40%, or at least about 50%, or at least about 60%, or at least about 70% for example from about 80% to about 100%, or from about 90% to about 99.9% per weight of perfume raw materials selected from d-muscenone 1, ambrox, polysantol, phenylethyl dimethyl carbinol, hydroxycitronellal, undecavertol, citronellol, linalool, p-cresyl methyl ether, cis-3-hexenol, clonal, limonene, tobacarol 2, tobacarol 3, tobacarol 1, b-naphthyl methyl ether.

The perfume formulation may be comprised in one or more perfume delivery systems. The perfume delivery system may comprise neat perfume, perfume microcapsules, pro-perfumes, polymer particles, functionalized silicones, polymer assisted delivery, molecule assisted delivery, fiber assisted delivery, amine assisted delivery, cyclodextrins, starch encapsulated accord, zeolite and inorganic carrier, and mixtures thereof. One or more of the perfume delivery system may comprise the preferred raw perfume material of the invention as defined above. Perfume delivery technologies, methods of making certain perfume delivery technologies and the uses of such perfume delivery technologies are disclosed in US 2007/0275866 A1, US 2004/0110648 A1, US 2004/0092414 A1, 2004/0091445 A1, 2004/0087476 A1, U.S. Pat. No. 6,531,444, 6,024,943, 6,042,792, 6,051,540, 4,540,721, and 4,973,422.

The composition may comprise from about 0.01% to about 15%, or from about 0.05% to about 10%, or even from about 0.1% to about 5% or from about 0.2% to about 2%, by weight of a perfume formulation.

### Amine Oxide

The composition may comprise an amine oxide.

Suitable amine oxide are according to the formula: R₁R₂R₃NO wherein each of R₁, R₂ and R₃ is independently a saturated or unsaturated, substituted or unsubstituted, linear or branched, hydrocarbon chain of from about 1 to about 30 carbon atoms. Preferred amine oxide surfactants to be used according to the present invention are amine oxides having the following formula: R₁R₂R₃NO wherein R₁ is an hydrocarbon chain comprising from about 1 to about 30 carbon atoms, preferably from about 6 to about 20, more preferably from about 8 to about 16 and wherein R₂ and R₃ are independently saturated or unsaturated, substituted or unsubstituted, linear or branched hydrocarbon chains comprising from about 1 to about 4 carbon atoms, preferably from about 1 to about 3 carbon atoms, and more preferably are methyl groups. R₁ may be a saturated or unsaturated, substituted or unsubstituted, linear or branched, hydrocarbon chain.

Suitable amine oxides for use herein are for instance preferably C₁₂-C₁₄ dimethyl amine oxide, commercially available from Albright & Wilson, C₁₂-C₁₄ amine oxides commercially available under the trade name Genaminox® LA, from Clariant or AROMOX® DMC from AKZO Nobel, from Huntsman Amine. C₁₂₋₁₄ alkyldimethyl, N-Oxide, EMPIGEN® OB/EG.

The composition may comprise from about 0.02% to about 30% per weight of amine oxide, for example from about 0.05% to about 20%, or from about 0.1% to about 10%, or from about 0.2 to about 5%, or from about 0.3 to about 2%, or from about 0.4 to about 1%.

### Nonionic Surfactant

The composition may comprise a nonionic surfactant.

The non-ionic surfactants may comprise alkoxylated surfactant, alkyl polysaccharides, block copolymers of ethylene oxide and propylene oxide, fluoro surfactants and silicon based surfactants, and mixtures thereof. For the purpose of the invention, amine oxides are not considered as nonionic surfactant.

A preferred class of non-ionic surfactants is alkoxylated nonionic surfactant. The alkoxylated nonionic surfactant of the present invention are either linear or branched, and contain from about 8 carbon atoms to about 16 carbon atoms in the hydrophobic tail, and from about 3 ethylene oxide units to about 25 ethylene oxide units in the hydrophilic head group. Examples of alkyl ethoxylates include Neodol 91-6®, Neodol 91-8® supplied by the Shell Corporation (P.O. Box 2463, 1 Shell Plaza, Houston, Tex.), and Alfonic 810-60® supplied by Condea Corporation, (900 Threadneedle P.O. Box 19029, Houston, Tex.). More preferred alkyl ethoxylates comprise from about 9 to about 12 carbon atoms in the hydrophobic tail, and from about 4 to about 9 oxide units in the hydrophilic head group. A most preferred alkyl ethoxylate is C₉₋₁₁ EO5, available from the Shell Chemical Company under the tradename Neodol 91-5®. Alkyl ethoxylates can also be derived from branched alcohols. For example, alcohols can be made from branched olefin feedstocks such as propylene or butylene.

The non-ionic surfactant may comprise alkyl polysaccharides. Such surfactants are disclosed in U.S. Pat. Nos. 4,565,647, 5,776,872, 5,883,062, and 5,906,973. The alkyl polysaccharides may comprise alkyl polyglycosides comprising five and/or six carbon sugar rings, such as six carbon sugar ring derived from glucose, i.e., alkyl polyglucosides (“APG”). The alkyl substituent in the APG chain length is preferably a saturated or unsaturated alkyl moiety containing from 8 to 16 carbon atoms, with an average chain length of 10 carbon atoms. C₈-C₁₆ alkyl polyglucosides are commercially available from several suppliers (e.g., Simusol” surfactants from Seppic Corporation, 75 Quai d'Orsay, 75321 Paris, Cedex 7, France, and Glucopon 220®, Glucopon 225®, Glucopon 425®, Plantaren 2000 N®, and Plantaren 2000 N UP®, from Cognis Corporation. Postfach 13 01 64, D 40551, Dusseldorf, Germany).

The non-ionic surfactant may have an HLB value comprised between about 10 and about 19.5, or between about 11 and about 19, or between about 12 and about 18.5. Preferably, the nonionic surfactant is liquid at about 25° C.

The composition may comprise from about 0.01% to about 15% per weight of nonionic surfactant, for example from about 0.02% to about 10%, or from about 0.05% to about 5%. The composition may comprise less than about 2%, or less than about 1%, or less than about 0.5%, or less than about 0.2% of nonionic surfactant.

The composition may comprise from about 0.01% to about 15% per weight of alkoxylated nonionic surfactant, for example from about 0.02% to about 10% or from about 0.05% to about 5%. The composition may comprise less than about 2% or less than about 1% or less than about 0.5% or less than about 0.2% of alkoxylated nonionic surfactant.

### Ratio

In the composition, specific weight ratio between ingredients or specific ratio between two weight ratios between ingredients may be preferred.

In the composition, the weight ratio (aminoalcohol solvent) to (alkali metal salt selected from carbonate salt, silicate salt, phosphate salt, and sulphate salt) is comprised between about 1 and about 25, or between about 2 and about 12, or between about 3 and about 10, or between about 4 and about 7.

In the composition, the weight ratio (monoethanolamine) to (alkali metal salt selected from carbonate salt, silicate salt, phosphate salt, and sulphate salt) may be comprised between about 1 and about 25, or between about 2 and about 12, or between about 3 and about 10, or between about 4 and about 7.

In the composition, the weight ratio (aminoalcohol solvent) to (sodium carbonate) may be comprised between about 1 and about 25, or between about 2 and about 12, or between about 3 and about 10, or between about 4 and about 7.

In the composition, the weight ratio (monoethanolamine) to (sodium carbonate) may be comprised between about 1 and about 25, or between about 2 and about 12, or between about 3 and about 10, or between about 4 and about 7.

In the composition, the weight ratio (amine oxide) to (non-ionic surfactant) may be comprised between about 1 and about 25, or between about 2 and about 12, or between about 3 and about 10, or between about 4 and about 7.

In the composition, the weight ratio (amine oxide) to (alkoxylated non-ionic surfactant) may be comprised between about 1 and about 25, or between about 2 and about 12, or between about 3 and about 10, or between about 4 and about 7.

In the composition, the weight ratio (amine oxide) to (aminoalcohol solvent) may be comprised between about 0.05 and about 20, or between about 0.12 and about 8, or between about 0.25 and about 4, or between about 0.5 and about 2.

In the composition, the weight ratio (amine oxide) to (monoethanolamine) may be comprised between about 0.05 and about 20, or between about 0.12 and about 8, or between about 0.25 and about 4, or between about 0.5 and about 2.

In the composition, the weight ratio (non-ionic surfactant) to (alkali metal salt selected from carbonate salt, silicate salt, phosphate salt, and sulphate salt) may be comprised between about 0.05 and about 20, or between about 0.12 and about 8, or between about 0.25 and about 4, or between about 0.5 and about 2.

In the composition, the weight ratio (non-ionic surfactant) to (sodium carbonate) may be comprised between about 0.05 and about 20, or between about 0.12 and about 8, or between about 0.25 and about 4, or between about 0.5 and about 2.

In the composition, the weight ratio (alkoxylated non-ionic surfactant) to (alkali metal salt selected from carbonate salt, silicate salt, phosphate salt, and sulphate salt) may be comprised between about 0.05 and about 20, or between about 0.12 and about 8, or between about 0.25 and about 4, or between about 0.5 and about 2.

In the composition, the weight ratio (alkoxylated non-ionic surfactant) to (sodium carbonate) may be comprised between about 0.05 and about 20, or between about 0.12 and about 8, or between about 0.25 and about 4, or between about 0.5 and about 2.

In the composition, the weight ratio (amine oxide) to (alkali metal salt selected from carbonate salt, silicate salt, phosphate salt, and sulphate salt) may be comprised between about 1 and about 25, or between about 2 and about 12, or between about 3 and about 10, or between about 4 and about 7.

In the composition, the weight ratio (amine oxide) to (sodium carbonate) may be comprised between about 1 and about 25, or between about 2 and about 12, or between about 3 and about 10, or between about 4 and about 7.

In the composition, the weight ratio (aminoalcohol solvent) to (alkoxylated non-ionic surfactant) may be comprised between about 1 and about 25, or between about 2 and about 12, or between about 3 and about 10, or between about 4 and about 7.

In the composition, the weight ratio (monoethanolamine) to (non-ionic surfactant) may be comprised between about 1 and about 25, or between about 2 and about 12, or between about 3 and about 10, or between about 4 and about 7.

In the composition, the weight ratio (aminoalcohol solvent) to (non-ionic surfactant) may be comprised between about 1 and about 25, or between about 2 and about 12, or between about 3 and about 10, or between about 4 and about 7.

In the composition, the weight ratio (monoethanolamine) to (alkoxylated non-ionic surfactant) may be comprised between about 1 and about 25, or between about 2 and about 12, or between about 3 and about 10, or between about 4 and about 7.

In the composition, the ratio of weight ratios [(aminoalcohol solvent) to (alkali metal salt selected from carbonate salt, silicate salt, phosphate salt, and sulphate salt)] to [(amine oxide) to (non-ionic surfactant)] may be comprised between about 0.05 and about 20, or between about 0.12 and about 8, or between about 0.25 and about 4, or between about 0.5 and about 2.

In the composition, the ratio of weight ratios [(monoethanolamine) to (alkali metal salt selected from carbonate salt, silicate salt, phosphate salt, and sulphate salt)] to [(amine oxide) to (non-ionic surfactant)] may be comprised between about 0.05 and about 20, or between about 0.12 and about 8, or between about 0.25 and about 4, or between about 0.5 and about 2.

In the composition, the ratio of weight ratios [(aminoalcohol solvent) to (sodium carbonate)] to [(amine oxide) to (non-ionic surfactant)] may be comprised between about 0.05 and about 20, or between about 0.12 and about 8, or between about 0.25 and about 4, or between about 0.5 and about 2.

In the composition, the ratio of weight ratios [(monoethanolamine) to (sodium carbonate)] to [(amine oxide) to (non-ionic surfactant)] may be comprised between about 0.05 and about 20, or between about 0.12 and about 8, or between about 0.25 and about 4, or between about 0.5 and about 2.

In the composition, the ratio of weight ratios [(aminoalcohol solvent) to (alkali metal salt selected from carbonate salt, silicate salt, phosphate salt, and sulphate salt)] to [(amine oxide) to (alkoxylated non-ionic surfactant)] may be comprised between about 0.05 and about 20, or between about 0.12 and about 8, or between about 0.25 and about 4, or between about 0.5 and about 2.

In the composition, the ratio of weight ratios [(monoethanolamine) to (alkali metal salt selected from carbonate salt, silicate salt, phosphate salt, and sulphate salt)] to [(amine oxide) to (alkoxylated non-ionic surfactant)] may be comprised between about 0.05 and about 20, or between about 0.12 and about 8, or between about 0.25 and about 4, or between about 0.5 and about 2.

In the composition, the ratio of weight ratios [(aminoalcohol solvent) to (sodium carbonate)] to [(amine oxide) to (alkoxylated non-ionic surfactant)] may be comprised between about 0.05 and about 20, or between about 0.12 and about 8, or between about 0.25 and about 4, or between about 0.5 and about 2.

In the composition, the ratio of weight ratios [(monoethanolamine) to (sodium carbonate)] to [(amine oxide) to (alkoxylated non-ionic surfactant)] may be comprised between about 0.05 and about 20, or between about 0.12 and about 8, or between about 0.25 and about 4, or between about 0.5 and about 2.

In the composition, the weight ratio (amine oxide) to (perfume formulation) may be comprised between about 0.2 and about 20, or between about 0.5 and about 8, or between about 1 and about 4.

In the composition, the weight ratio (MEA) to (perfume formulation) may be comprised between about 0.2 and about 20, or between about 0.5 and about 8, or between about 1 and about 4.

The inventors have discovered that the relative quantity of the above ingredients was contributing in providing a composition which delivers a good overall cleaning experience.

### Antimicrobial Agent

The composition may comprise antimicrobial agent or mixtures thereof.

The composition may comprise from about 0.01 to about 0.3%, or from about 0.02 to about 0.15%, by weight of the composition of an antibacterial agent. The antibacterial agent may comprise a salt of quaternium ammonium chloride.

Suitable antimicrobial agents used herein the present invention may comprise alkyl dimethyl benzyl ammonium chloride, alkyl dimethyl ethylbenzyl ammonium chloride; didecyl dimethyl ammonium chloride, and mixtures thereof. Antimicrobial agents may comprise a (1:1) blend of alkyl dimethyl benzyl ammonium chloride and alkyl dimethyl ethylbenzyl ammonium chloride.

Such antimicrobial agents are typically stable in the composition.

### Solvent

The composition may comprise a solvent, or mixtures thereof. Suitable solvent is selected from the group consisting of ethers and diethers having from about 4 to about 14 carbon atoms, preferably from about 6 to about 12 carbon atoms, and more preferably from about 8 to about 10 carbon atoms; glycols or alkoxylated glycols; alkoxylated aromatic alcohols; aromatic alcohols; alkoxylated aliphatic alcohols; aliphatic alcohols; C₈-C₁₄ alkyl and cycloalkyl hydrocarbons and halohydrocarbons; C₆-C₁₆ glycol ethers; terpenes; and mixtures thereof.

### Chelating Agents

The composition may comprise a chelating agent or mixtures thereof. Chelating agents can be incorporated in the compositions herein in amounts ranging from about 0.0% to about 10.0% by weight of the total composition, preferably about 0.01% to about 5.0%.

Suitable phosphonate chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S, S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates for use herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-_acetic acid (MGDA). Further carboxylate chelating agents for use herein include salicylic acid, aspartic acid, glutamic acid, glycine, malonic acid or mixtures thereof.

### Additional Surfactant

As a surfactant, the composition preferably comprises nonionic surfactant and does not comprise cationic or anionic surfactant.

The anionic surfactant may comprise alkyl sulphonates, alkyl aryl sulphonates, alkyl sulphates, alkyl alkoxylated sulphates, C₆-C₂₀ alkyl alkoxylated linear or branched diphenyl oxide disulphonates, and mixtures thereof.

The composition may comprise less than about 5%, preferably less than about 3% or less than about 2% or less than about 1% or less than 0.5% or less than about 0.2%, or less than about 0.1% by weight of anionic surfactant.

The composition may comprise less than about 5%, preferably less than about 3% or less than about 2% or less than about 1% or less than about 0.5% or less than about 0.2%, or less than about 0.1% by weight of cationic surfactant.

The composition may comprise less than about 5%, preferably less than about 3% or less than about 2% or less than about 1% or less than about 0.5% or less than about 0.2% by weight of surfactant.

While the composition of the invention comprises a perfume formulation, it is particularly surprising that the compositions of the invention may be particularly stable even when they comprise a low level of surfactant.

The weight ratio of nonionic surfactant to (anionic surfactant+cationic surfactant) in the composition is preferably above about 0.02, preferably above about 0.05 preferably above about 0.1 preferably above about 0.2, preferably above about 0.5, preferably above about 1 or about 2.

The weight ratio of amine oxide to (anionic surfactant+cationic surfactant) in the composition is preferably above about 0.1, preferably above about 0.2, preferably above about 0.5, preferably above about 1, preferably above about 2 or about 5.

### Other Ingredients

The composition may further include any suitable ingredients such as builders, polymers, preservative, hydrotropes, stabilisers, radical scavengers, bleaches, bleaches activators, soil suspenders, anti-dusting agent, dispersant, pigments, silicones, abrasives, dye transfert agent, brighteners, dye transfer inhibitor, thickener, fatty acid, branched fatty alcohol, and/or dye.

### The Composition

The composition may be a liquid composition.

The composition may have a viscosity at shear rate 10 s¹ of 1 mPa·s or greater, more preferably of from about 1 to about 20.000 mPa·s, or from about 1.5 to about 100 mPa·s, or from about 1.5 to about 30 mPa·s, or from about 2 to about 10 mPa·s, or from about 2.5 to about 5 mPa·s at about 20° C. when measured with a DHR 1 rheometer (TA instruments) using a 2° 40 mm diameter cone/plate geometry, with a shear rate ramp procedure from about 1 to about 1000 s⁻¹.

The composition is typically an aqueous composition and therefore comprises water. The composition may comprise from about 50% to about 98%, even more preferably of from about 75% to about 97% and most preferably 80% to about 97% by weight of water.

The pH of the composition according to the present invention may be from about 9 to about 14, or from about 9.5 to about 13 or from about 10 to about 12 or from about 10.5 to about 11.5.

The composition may comprise an acid or a further base to adjust pH as appropriate.

A suitable acid for use herein is an organic and/or an inorganic acid. A preferred organic acid for use herein has a pKa of less than about 6. A suitable organic acid is selected from the group consisting of citric acid, lactic acid, glycolic acid, succinic acid, glutaric acid and adipic acid and a mixture thereof. A suitable inorganic acid is selected from the group consisting hydrochloric acid, sulphuric acid, phosphoric acid and a mixture thereof. A typical level of such an acid, when present, is of from about 0.01% to about 20%, from about 0.1% to about 15%, or from about 1% to about 10% by weight of the total composition.

A suitable further base to be used herein is an organic and/or inorganic base. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide. Other suitable bases include ammonia. Typical levels of such bases, when present, are of from about 0.01% to about 5.0%, or from about 0.05% to about 3.0%.

The composition may be packaged in a variety of suitable detergent packaging known to those skilled in the art. The compositions can be packaged in conventional detergent plastic bottles. Preferably the composition is packaged in a spray dispenser, such as a trigger spray dispenser or pump spray dispenser. In one preferred embodiment the compositions herein may be packaged in manually or electrically operated spray dispensing containers. The container may be made of synthetic organic polymeric plastic materials. The composition may be in compacted form, and may be suitable to be diluted, for example 15 times before use.

Accordingly, the present invention also concerns a spray dispenser, preferably in a trigger spray dispenser or pump spray dispenser, comprising a composition according to the invention.

Indeed, said spray-type dispensers allow to uniformly apply to a relatively large area of a surface to be cleaned the composition. Such spray-type dispensers are particularly suitable to clean inclined or vertical surfaces. Suitable spray-type dispensers to be used according to the present invention include manually operated foam trigger type dispensers sold for example by Specialty Packaging Products, Inc. or Continental Sprayers, Inc. These types of dispensers are disclosed, for instance, in U.S. Pat. No. 4,701,311 to Dunnining et al. and U.S. Pat. No. 4,646,973 and U.S. Pat. No. 4,538,745 both to Focarracci. Particularly preferred to be used herein are spray-type dispensers such as T 8500®commercially available from Continental Spray International or T 8100® commercially available from Canyon, Northern Ireland. In such a dispenser, the liquid composition is divided in fine liquid droplets resulting in a spray that is directed onto the surface to be treated. Indeed, in such a spray-type dispenser the composition contained in the body of said dispenser is directed through the spray-type dispenser head via energy communicated to a pumping mechanism by the user as said user activates said pumping mechanism. More particularly, in said spray-type dispenser head the composition is forced against an obstacle, e.g., a grid or a cone or the like, thereby providing shocks to help atomise the liquid composition, i.e., to help the formation of liquid droplets.

### Examples

The following examples will further illustrate the invention.

Examples 1 to 6 are hard surface cleaner compositions. Those compositions are stable, provide good cleaning performance, good shine to the surface and preserve the surface safety of the surface to be cleaned.

Compositions of examples 1-4 are sprayable compositions suitable to clean hard surfaces. Composition 5 and 6 are concentrated compositions which are typically diluted about 15 times before being used, for example in a spray.

The compositions 1-6 are prepared by mixing the ingredients.

| | weight percentage | | | | | |
|---|---|---|---|---|---|---|
| | example | example | example | example | example | example |
| Ingredient | 1 | 2 | 3 | 4 | 5 | 6 |
| Amine oxide (1) | 0.5 | 0.5 | 0.4 | 0.7 | 7.5 | 7.5 |
| Nonionic surfactant (2) | 0.1 | 0.1 | 0.05 | 0.2 | 1.5 | 1.5 |
| Sodium carbonate (3) | 0.1 | 0.1 | 0.2 | 0.05 | 1.5 | 1.5 |
| MEA (4) | 0.5 | 0.5 | 0.7 | 0.4 | 7.5 | 7.5 |
| Perfume Formulation (5) | 0.3 | 0.2 | 0.1 | 0.05 | 3 | 3 |
| Antimicrobial agent (6) | | 0.1 | | 0.2 | | 1.5 |
| Preservative (7) | 0.01 | | 0.02 | | 0.15 | |
| dye | 0.001 | 0.01 | 0.0001 | 0.002 | 0.015 | 0.015 |
| water | qsp | qsp | qsp | qsp | qsp | qsp |

(1) Amine, C₁₂₋₁₄ alkyldimethyl, N-Oxide, EMPIGEN ® OB/EG, Huntsman
(2) Alfonic ® 10-8 Ethoxylate, Sasol and/or Marlipal C₁₀EO₈, Sasol and/or Neodol C₉₋₁₁EO₈, SHELL CHEMICAL CO
(3) Solvay S.A./Sodium carbonate
(4) Mitsui Chemicals Inc./Monoethanolamine
(5) Perfume formulation preferably comprising a low percentage of ester, α, β-unsaturated aldehyde, and α, β-unsaturated ketone
(6) Barquat 4280Z or Bardac 2280, Lonza
(7) Proxel, ARCH UK BIOCIDES LTD

Unless otherwise specified, percentages and ratio refers to weight percentage and weight ratio.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising:
(a) an aminoalcohol solvent,
(b) an alkali metal salt selected from carbonate salt, silicate salt, phosphate salt, and sulphate salt, and
(c) a perfume formulation,
wherein the weight ratio of aminoalcohol solvent to alkali metal salt selected from carbonate salt, silicate salt, phosphate salt, and sulphate salt is comprised between about 1 and about 25,
and wherein the perfume formulation comprises at most about 50%, per weight of perfume raw materials comprising an ester function, an α, β-unsaturated aldehyde function and/or an α, β-unsaturated ketone function.

2. The detergent composition according to claim 1, wherein the perfume formulation comprises at most about 20% of perfume raw materials comprising an ester function, an α, β-unsaturated aldehyde function and/or an α, β-unsaturated ketone function.

3. The detergent composition according to claim 1, further comprising a nonionic surfactant, and an amine oxide.

4. The detergent composition according to claim 1, comprising from about 0.01% to about 10% by weight of amine oxide, from about 0.01% to about 10% by weight of nonionic surfactant, from about 0.01% to about 10% by weight of aminoalcohol solvent, and from about 0.01% to about 10% by weight of an alkali metal salt selected from carbonate salt, silicate salt, phosphate salt, and sulphate salt.

5. The detergent composition according to claim 1 further comprising quaternium ammonium chloride antibacterial agent.

6. The detergent composition according to claim 1 being aqueous, liquid, and having a pH between about 10 and about 12.

7. The detergent composition according to claim 1, comprising monoethanol amine.

8. Detergent composition according to claim 1, comprising an alkoxylated surfactant.

9. Detergent composition according to claim 1, comprising sodium carbonate.

10. Spraying device comprising a composition according to claim 1.
